(19) United States
(12) Patent Application Publication
(10) Pub. No.: US 2026/0237303 A1
(43) Pub. Date: Aug. 13, 2026

(54) Multi-Model Flight Path Prediction System for Unmanned Aerial Systems

(71) Applicant: Camgian Corporation, Starkville, MS (US)

(72) Inventors: Andrew Kirk, Mount Juliet, TN (US); Brandon Carson, Nashville, TN (US); Cameron Wood, Titus, AL (US)

(73) Assignee: Camgian Corporation, Starkville, AZ (US)

(21) Appl. No.: 19/463,707

(22) Filed: Jan. 29, 2026

Related U.S. Application Data
(60) Provisional application No. 63/758,248, filed on Feb. 13, 2025.

(51) Int. Cl. G08G 5/34; G06F 17/14

(52) U.S. Cl. CPC G08G 5/34; G06F 17/141

(57) ABSTRACT

The present invention relates to an adaptive multi-model flight path prediction (FPP) system configured to improve the accuracy and robustness of unmanned aerial system (UAS) trajectory forecasting. The system analyzes flight path data in the frequency domain to classify the underlying motion pattern as either periodic or non-periodic. Based on this classification, a control mechanism dynamically selects between a periodic predictor optimized for recurrent or surveillance-type flight behaviors and a non-periodic predictor designed to capture irregular, erratic, or evasive motion. This adaptive design enables seamless transitions between prediction modes, maintaining accuracy across a wide range of UAS operational patterns and improving performance where conventional single-model systems exhibit degraded results.

### FIELD OF THE INVENTION

The present invention relates to predictive systems for unmanned aerial systems (UAS), specifically to methods and systems that enable advanced prediction of UAS flight paths using a multi-model approach, optimizing accuracy in both periodic and non-periodic flight patterns.

### BACKGROUND

Unmanned aerial systems (UAS) are increasingly used in a variety of operational scenarios, including intelligence, surveillance, reconnaissance (ISR), and direct, often erratic, missions. The ability to predict UAS flight paths is critical for assessing intent, evaluating threat potential, and improving defensive targeting. Traditional flight path prediction (FPP) systems rely on static, singular model algorithms, limiting their ability to adapt to UAS that shift between regular and irregular flight behaviors. The present invention provides a dynamic system and method to adapt to UAS that address these limitations.

### SUMMARY OF THE INVENTION

This disclosure is summarized below for the purpose of introducing embodiments of the invention. The ultimate scope of the disclosure is to be limited only to the claims that follow the specification.

It is an object of the present invention to provide an adaptive multi-model flight path prediction (FPP) system configured to improve the accuracy and robustness of unmanned aerial system (UAS) trajectory forecasting across a wide range of operational patterns, thereby improving performance over traditional single-model systems.

It is another object of the present invention to analyze UAS flight path data in the frequency domain to classify the underlying motion pattern as either periodic or non-periodic, which may involve transforming the track data into a frequency-domain representation, potentially using a Discrete Fourier Transform (DFT) or an equivalent technique.

It is another object of the present invention to dynamically select a prediction pathway using a control and routing mechanism based on whether the underlying motion pattern is periodic or non-periodic.

It is another object of the present invention to utilize a periodic prediction module optimized for recurrent flight behaviors, and configured to generate a single, high-confidence trajectory forecast.

It is a further object of the present invention to implement the periodic prediction by using a transformer-based temporal model or a recurrent framework capable of learning periodic dependencies.

It is another object of the present invention to utilize a non-periodic prediction module to capture irregular, erratic, evasive, or targeted motion, which may be implemented using a memory-augmented network architecture.

It is another object of the present invention to generate a set of candidate future paths via the non-periodic prediction pathway, which are aggregated into a probabilistic heatmap or “cone of probability” that visualizes uncertainty over future motion.

It is another object of the present invention to transform the discrete candidate paths into a continuous probability field using a statistical smoothing technique.

It is another object of the present invention to identify a most probable trajectory forecast from the probabilistic heatmap via a path selection process.

It is another object of the present invention that the path selection process be performed through a graph-based search that utilizes a scoring function balancing spatial continuity with the probability of occurrence.

It is another object of the present invention to dynamically change to the alternative prediction module if the data indicate a transition in behavior.

It is another object of the present invention to support concurrent operation of the frequency analysis module and the prediction modules so that the control and routing mechanism may select the appropriate prediction result for downstream use.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 illustrates a flowchart of an architecture of the adaptive multi-model flight path prediction (FPP) system.

FIG. 2 illustrates representative simulated UAS flight paths with examples of periodic and non-periodic motion patterns.

FIG. 3 illustrates an example workflow flowchart of the frequency analysis and signal routing process.

FIG. 4 illustrates example trajectories and corresponding frequency-domain representations for non-periodic and periodic flight paths.

FIG. 5 illustrates a workflow flowchart of a periodic prediction module.

FIG. 6 illustrates a flowchart of a processing workflow of the non-periodic prediction module.

FIG. 7 illustrates a visualization process of the non-periodic prediction module.

### DESCRIPTION OF PREFERRED EMBODIMENT

The following describes preferred and alternative embodiments of an adaptive multi-model flight path prediction (FPP) system for forecasting unmanned aerial system (UAS) trajectories. The system 100 comprises cooperating modules that analyze sensor detection 110 data, fuse detections into positional track data (120 and 130), characterize motion patterns by analyzing their frequencies 140, select an appropriate prediction pathway by using a control and routing mechanism 150, and generate a forecast of either future periodic 160 or non-periodic motion 170. Specific algorithmic realizations (e.g., discrete Fourier transforms, transformer-based predictors, memory-augmented predictors) may be used in these modules, but the invention is not limited to any particular algorithm.

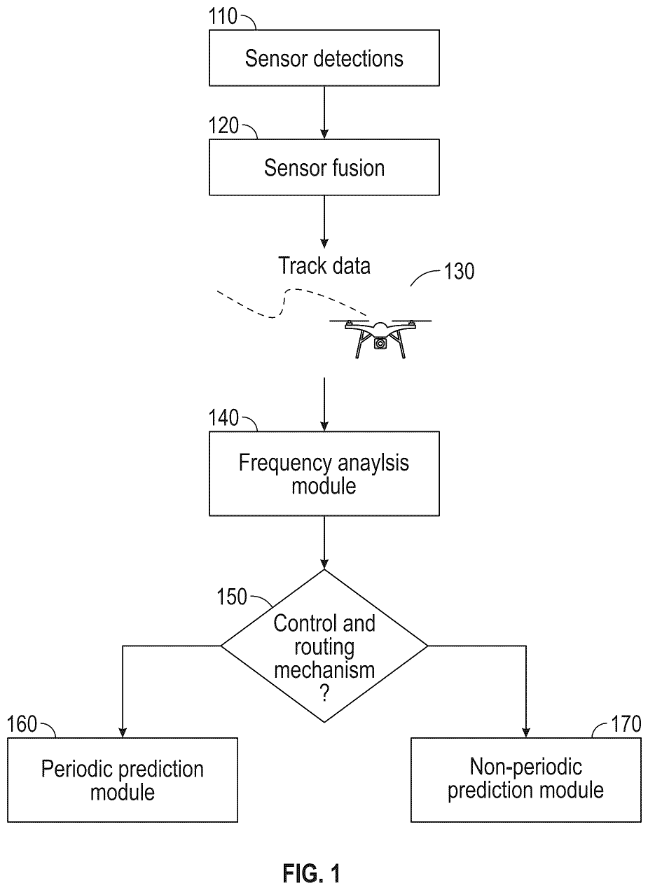

FIG. 1 illustrates an embodiment of the processing flow. The system ingests sensor detections 110, which serve as the initial data source. The detections 110 may be obtained from one or more sensing modalities, such as electro-optical/infrared (EO/IR) sensors, radar, acoustic sensors, LiDAR, or other sources capable of providing positional or kinematic information for a UAS. The detections 110 are processed through a sensor fusion stage 120 to produce positional track data 130 defining an input path. A frequency analysis module 140 transforms the track data 130 into a frequency-domain representation and evaluates the resulting spectrum to determine whether the motion exhibits periodic structure. When energy within representative frequency ranges exceeds a threshold, the track data 130 is classified as periodic; otherwise, it is classified as non-periodic. The frequency-domain transform may be implemented using a Discrete Fourier Transform (DFT) or an equivalent technique. Other transforms providing substantially similar information may be substituted without departing from the scope of the invention.

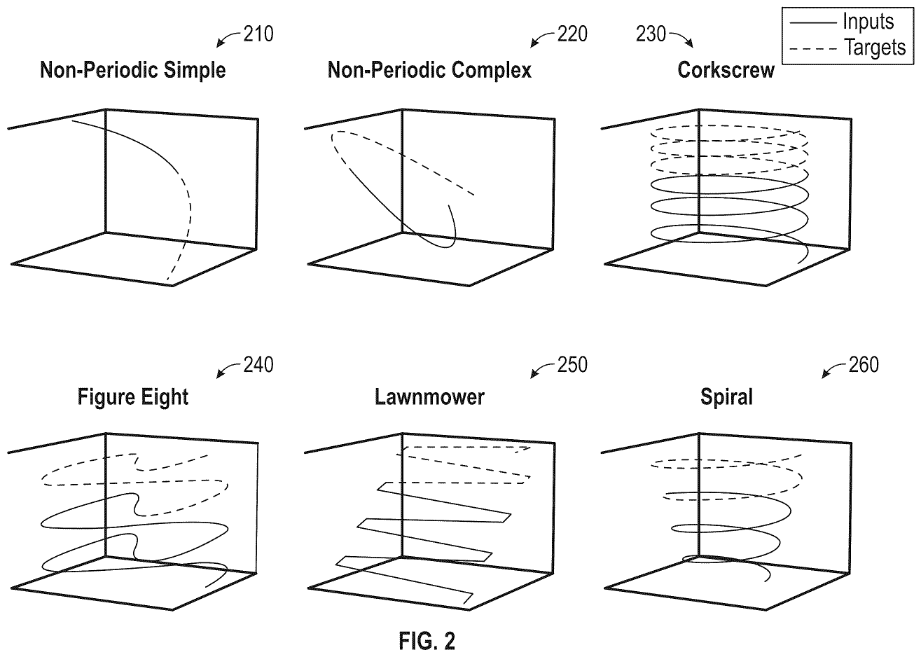

For tracks classified as periodic, the system 100 routes data to a periodic prediction module 160. This module is configured to generate a single, high-confidence trajectory forecast for flight behaviors exhibiting recurring motion. FIG. 2 illustrates examples of these flight behaviors, such as corkscrew 230, figure eight 240, lawnmower 250, or spiral 260. The periodic prediction module 160 may employ a transformer-based temporal model or other sequence model capable of capturing repeating dynamics; the periodic prediction module 160 is not limited to any particular model architecture.

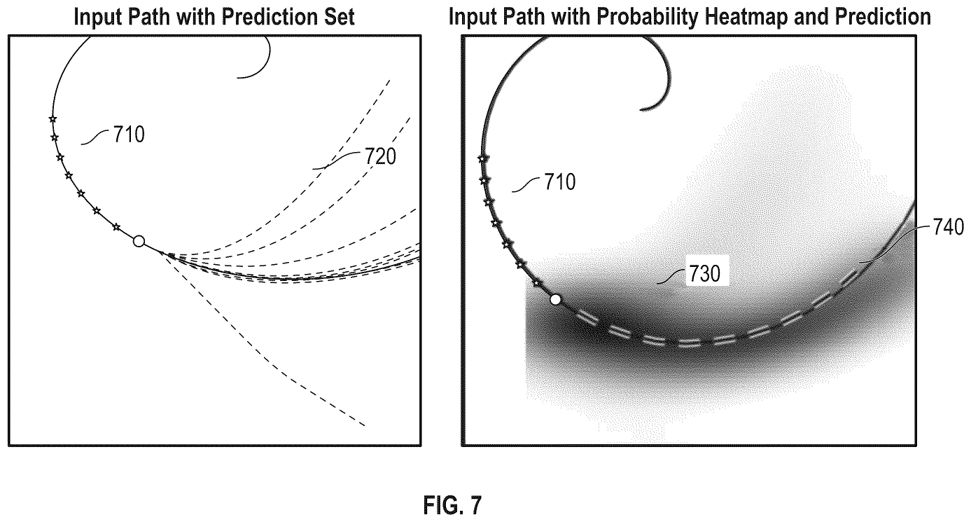

For tracks classified as non-periodic, the system 100 routes data to a non-periodic prediction module 170 configured to model complex, irregular, or evasive dynamics as illustrated in the non-periodic simple dynamic 210 and the non-periodic complex dynamic 220. As illustrated in FIG. 7, this module processes the full trajectory 710 and produces a set of candidate future paths 720 that are aggregated into a probabilistic heatmap 730 that is an area of probable trajectories. The resulting probabilistic heatmap 730 is used to generate a single representative path prediction 740, which the system 100 may use to identify the most likely continuation or guide subsequent decision processes. The non-periodic prediction module 170 may utilize alternative architectures that achieve substantially similar functionality, such as a memory-augmented network, recurrent architecture, or other model class suited to non-repetitive motion.

In the system 100, the modules operate sequentially, with the frequency analysis module 140 determining the routing to one of the prediction modules 160 or 170. In alternative embodiments, the track data may be provided concurrently to the frequency analysis module 140 and both prediction modules 160 and 170, allowing the system 100 to begin generating forecasts in parallel. In those configurations, the output of the frequency analysis module 140 is used by the control and routing mechanism 150 to select the appropriate prediction result for downstream use. This parallel-processing approach may reduce end-to-end analysis latency at the cost of increased computational load, and may incorporate synchronization logic to ensure temporal consistency among concurrently executing modules.

### Training and Simulation Framework

In an alternate embodiment, FPP model training and evaluation may be supported by a simulation framework that generates a diverse set of flight trajectories. This framework produces trajectories spanning both unstructured motion like the random or approximately linear segments 210 and 220, and the structured patterns like the corkscrew 230, figure eight 240, lawnmower 250, and spiral 260, providing representative variability observed in operational UAS behavior. The framework is provided to support robustness of the prediction modules 160 and 170 and is not limiting to this invention.

The simulation framework may incorporate environmental and sensor noise and may produce smooth or abrupt transitions between patterns so that the prediction modules 160 and 170 learn to react to changes as they occur. By exposing the models to both steady behaviors and transitional dynamics, the system 100 can be configured to recognize and adapt to evolving motion conditions in real time.

Training on a diverse set of simulated trajectories promotes balanced learning across trajectory types and noise conditions, reducing sensitivity to any single pattern and improving generalization to real-world operating environments.

### Prediction Processing and Output

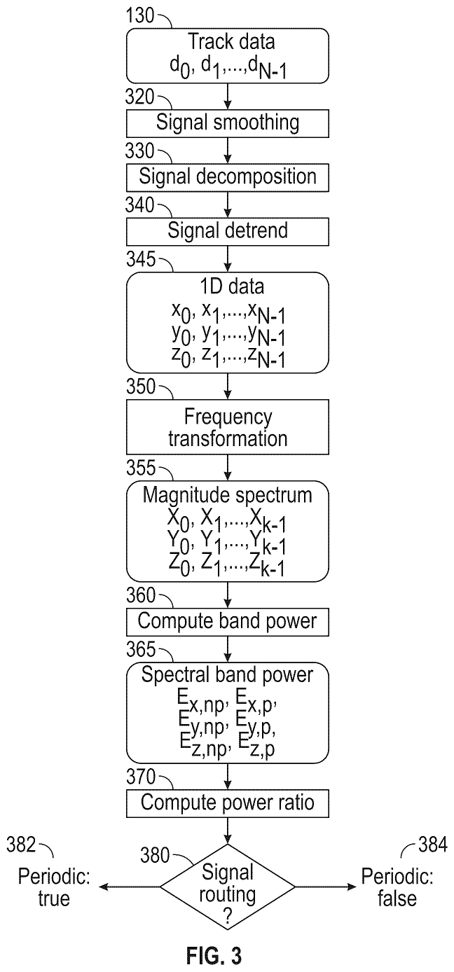

Upon receiving the processed track data 130, the system 100 applies the frequency-analysis module 140 to evaluate the dominant motion characteristics of the flight path. Based on this frequency analysis, the control and routing mechanism 150 determines which predictive pathway to engage. If the analysis identifies strong periodic features, the track data is processed into a set of 1D data 345, as shown in FIG. 3 and described below, are routed to the periodic prediction module 160 for deterministic trajectory forecasting. Conversely, for motion identified as non-periodic, the system 100 selects the non-periodic prediction module 170 which may produce multiple candidate trajectories 720. These trajectories 720 can be aggregated into a probability heatmap 730, which is a probabilistic forecast representation in three dimensions that expresses uncertainty across feasible future paths and supports downstream visualization and decision making.

The probabilistic forecast representation may be rendered as a probability heatmap 730 to highlight higher-probability regions of travel. In some embodiments, a path selection process identifies a most-likely trajectory forecast 740 within this region using a cost- or heuristic-based search that prioritizes high-likelihood areas while accounting for path feasibility. Alternative optimization or search methods providing substantially similar functionality may be used without departing from the scope of the invention.

This approach provides: (i) versatility across diverse behaviors by selecting prediction pathways based on measured motion characteristics; (ii) accuracy under both stable and rapidly changing conditions by routing tracks to predictors suited to periodic or non-periodic dynamics; and (iii) improved operational assessment via probabilistic representations and optimized path selection that enable earlier and more reliable interpretation of future motion.

The following sections describe the principal components of the system and their operation, including frequency-based classification, periodic prediction, non-periodic prediction, and generation and use of probabilistic forecast representations.

### Control and Routing Mechanism

A control and routing mechanism 150 manages data flow between the prediction modules 160 and 170. The control and routing mechanism 150 receives the frequency analysis module's 140 output, determines whether the motion is periodic or non-periodic, and dynamically routes the processed track data 130 to the corresponding prediction module 160 or 170. The control and routing mechanism 150 also manages synchronization between modules, ensuring that the predictions remain consistent with real-time data inputs. It is also possible the control and routing mechanism 150 may incorporate thresholds, confidence metrics, or decision rules to refine routing under uncertain or mixed-motion conditions.

### Periodic Prediction Module

Once a flight path is classified as periodic, the periodic prediction module 160 generates a trajectory forecast optimized for structured or recurring motion. The module 160 models temporal dependencies and recurring spatial patterns such as corkscrew 230, figure eight 240, lawnmower 250, or spiral 260. In some embodiments, the module 160 processes the trajectory as individual components along the X, Y, and Z axes and reconstructs a composite three-dimensional prediction. The periodic prediction module 160 is designed to output a single, high-confidence forecast that captures the dominant motion trend. Various sequential modeling architectures may be used, such as transformer-based or recurrent frameworks capable of learning periodic dependencies.

### Non-periodic Prediction Module

For motion classified as non-periodic, the non-periodic prediction module 170 generates forecasts representing irregular, erratic, or directed trajectories. This module 170 is designed to capture non-repetitive dynamics and uncertainty in future motion and may produce multiple candidate trajectories or a probability distribution over likely paths, which can be represented as a probabilistic heatmap 730. The system 100 may use this distribution to identify the most likely continuation of the flight path or to provide a probabilistic visualization for decision-making. The non-periodic prediction module 170 may employ neural, statistical, or memory-augmented architectures suitable for modeling complex and unpredictable motion behaviors.

### Frequency Analysis Module

The frequency analysis module 140 processes incoming UAS flight path data 130 to determine whether the trajectory exhibits periodic or non-periodic motion characteristics. By examining the spectral distribution of motion energy, the module 140 identifies dominant frequency components that describe the nature of the flight pattern. This spectral characterization serves as the basis for selecting an appropriate predictive pathway within the system.

The frequency analysis module 140 converts flight path data 130 from the time domain into the frequency domain. This transformation enables the system 100 to detect temporal regularities and recurring motion behaviors that are not readily visible in raw positional data. Periodic motion, such as that associated with reconnaissance or orbiting flight, manifests as distinct peaks or concentrations of energy within the transformed spectrum.

The steps in the workflow as shown in FIG. 3 include the following:

### Preprocessing Track Data

The module 140 receives track data 130 from the sensor-fusion process 120. These data 310 represent the UAS's position over time in three-dimensional Cartesian coordinates, denoted by d₀, d₁, . . . dₙ₋₁. The trajectory is smoothed and normalized 320 to mitigate sensor noise and decomposed 330 into one-dimensional signals (x₀, x₁, . . . xₙ₋₁; y₀, y₁, . . . yₙ₋₁; z₀, z₁, . . . zₙ₋₁) 345 to permit independent analysis along each spatial axis. A detrending operation 340 may be included to remove slow drift or bias, isolating the oscillatory components that contribute to periodic motion signatures.

### Frequency Transformation and Spectrum Generation

A frequency-domain transform 350 is applied to each spatial component, producing a magnitude spectrum that represents the energy distribution across frequency indices. This process may employ a discrete Fourier transform (DFT) defined by:

$$X [ k ] = {\sum }_{n = 0}^{N - 1} x [ n ] \cdot {e}^{- j \frac{2 π}{N} kn} , \qquad Equation 1$$

In this expression, x[n] represents the UAS positional value at time sample n, N denotes the total number of samples in the time series, and k is the frequency index that identifies each spectral component. The exponential term

$$X [ k ] = {\sum }_{n = 0}^{N - 1} x [ n ] \cdot {e}^{- j \frac{2 π}{N} k n} , \qquad Equation 1$$

acts as a set of complex sinusoidal basis functions used to decompose the time-varying signal into a weighted sum of its constituent frequencies. The resulting magnitude spectrum (X₀, X₁, . . . Xₖ₋₁; Y₀, Y₁, . . . Yₖ₋₁; Z₀, Z₁, . . . Zₖ₋₁) 355 quantifies the magnitude and phase of each frequency component present in the trajectory. Other equivalent frequency analysis methods may be substituted without departing from the scope of the invention.

### Routing and Decision Output

The frequency-analysis module 140 communicates its computed spectral information to the control and routing mechanism 150, which determines the appropriate prediction pathway based on the observed frequency characteristics of the UAS flight track data 130. Using the magnitude spectrum 355 produced by the frequency transformation 350, the control and routing mechanism 150 computes the spectral band power 360 and the resulting band-power values 365, and then computes relative band power ratios 370 to decide whether the trajectory exhibits periodic or non-periodic characteristics, subsequently directing 380 the data to the corresponding prediction module 160 or 170 for further processing.

The control and routing mechanism 150 ensures that predictive model selection remains consistent with real-time flight data 130. As new track inputs are received, the system 100 continuously evaluates whether the motion characteristics still align with those identified by the frequency-analysis module 140. If the ongoing data indicate a change in behavior, for example, a transition from periodic loitering to irregular or evasive motion, the control mechanism 150 dynamically reassigns the data stream to the corresponding prediction module 160 or 170. This adaptive routing process keeps the active prediction state synchronized with the current flight behavior, rather than fixed to the initial assessment.

### Threshold Determination

The magnitude spectrum 355 is analyzed to identify peaks that correspond to dominant motion frequencies within each spatial axis. The band-power computation stage 360 aggregates the magnitude values within designated frequency ranges associated with periodic and non-periodic motion. This process yields a set of spectral band powers, denoted as (E_{x,np}, E_{y,np}, E_{z,np}, E_{x,p}, E_{y,p}, E_{z,p},) 365, representing energy contributions from non-periodic and periodic frequency bands, respectively.

To discriminate between flight behaviors, the ratio of power 370 is computed in the periodic band to that in the non-periodic band for each axis. This spectral band-power ratio 370 serves as a normalized indicator of periodicity and is evaluated against an empirical threshold to produce a binary routing decision 380 that determines whether the data are processed by the periodic or non-periodic prediction module.

If the power ratio 370 within selected frequency regions exceeds an empirically derived threshold, the motion is classified as periodic 382; otherwise, it is classified as non-periodic 384. Periodic motion typically exhibits stronger spectral energy at mid-range frequencies associated with oscillatory patterns such as corkscrew 230, figure eight 240, lawnmower 250, or spiral 260. Non-periodic motion exhibits energy concentrated toward lower frequencies, indicative of directional or erratic flight without sustained repetition.

The precise frequency ranges and thresholds may be adaptively determined based on factors such as sampling rate, observation duration, or vehicle dynamics. Very high-frequency components, often representing measurement noise, may be excluded from classification.

### Visualization of Frequency Analysis

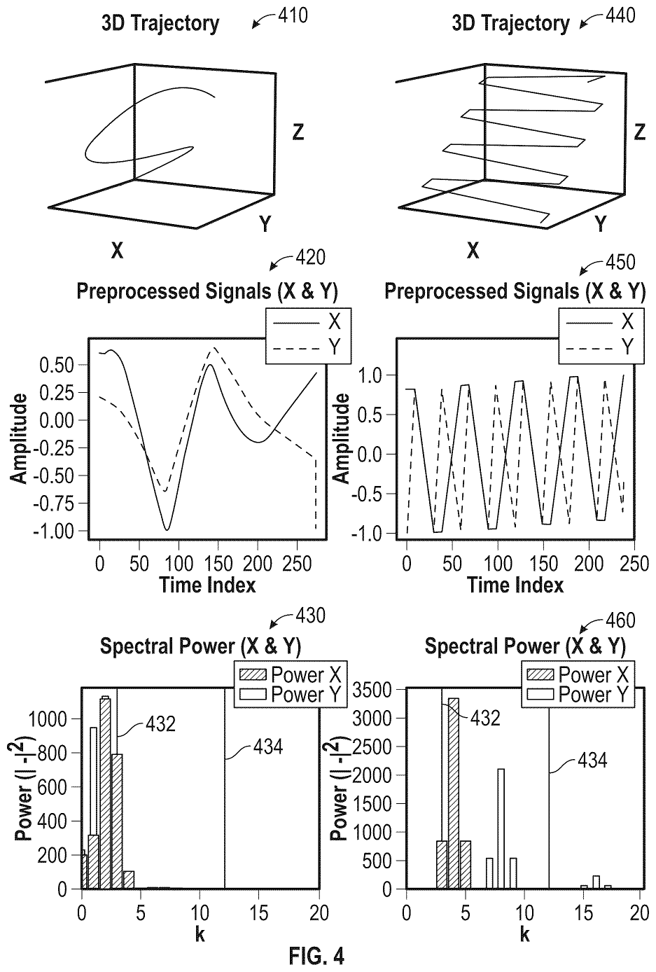

FIG. 4 illustrates representative examples of two UAS flight paths and their corresponding frequency-domain representations. Non-periodic 3D trajectory 410 and periodic trajectory 440 illustrate the three-dimensional flight trajectories used as input. Preprocessed one-dimensional components graphs for the non-periodic trajectory 420 and the periodic trajectory 450 specifically illustrate the detrended X and Y axis signals derived from the trajectories 410 and 440. The resulting spectral power distributions for the non-periodic trajectory 430 and the periodic trajectory 460 for each axis is shown. The vertical bars 432 and 434 indicate the example frequency ranges associated with the periodic and non-periodic trajectory boundaries. Low-frequency, non-periodic behavior is characterized by dominant spectral energy in the band extending up to vertical bar 432. The mid-frequency band, bounded by vertical bars 432 and 434, corresponds to periodic motion in the flight track data 130. Spectral power above vertical bar 434 reflects high-frequency content typically attributable to sensor noise and is not used for motion characterization

The non-periodic trajectory 410 is decomposed X and Y components 420 yield spectra 430 dominated by low-frequency power, indicating an absence of repeating motion or sustained oscillatory behavior.

The periodic trajectory 440 is decomposed into corresponding X and Y components 450 exhibiting clear repeating patterns, and the resulting spectral power 460 is concentrated in mid-range frequency bins characteristic of periodic motion.

The vertical bars 432 and 434, which mark the boundaries between the low-, mid-, and high-frequency ranges, as described above, are adaptive and depend on factors such as sampling rate, observation duration, and operational context. The specific thresholds shown in this embodiment are illustrative and not limiting.

### Periodic Prediction Module

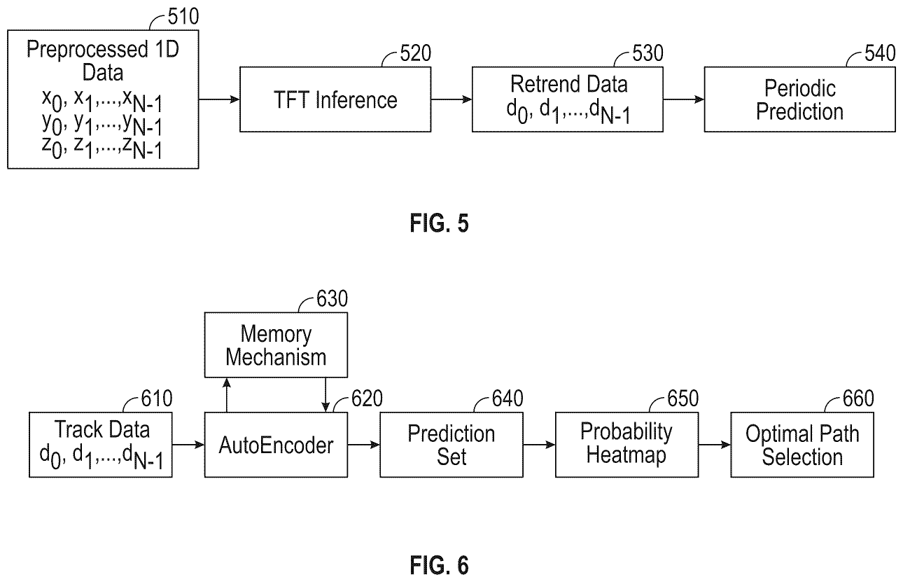

The periodic prediction module 160, illustrated in FIG. 5, models flight paths that exhibit repeating or oscillatory behavior. In the present embodiment, this module 160 is implemented using a temporal sequence-learning architecture such as a Temporal Fusion Transformer (TFT), which is capable of modeling both short and long-term temporal dependencies in periodic motion data. This module 160 processes trajectories with strong periodic structure, such as corkscrew 230, figure eight 240, lawnmower 250, and spiral 260, by learning the temporal dependencies that define their recurring patterns.

The overall workflow, shown in FIG. 5, illustrates a processing sequence in which preprocessed one-dimensional input data 510 are passed through a time-series inference stage 520, re-trended 530, and reconstructed into a final periodic prediction 540. This process is applied independently to each spatial axis and then recombined into a unified three-dimensional trajectory forecast.

### Dimensional Decomposition and Modeling

To simplify prediction, the module 160 decomposes the three-dimensional flight trajectory into independent one-dimensional components 510 along the X, Y, and Z axes. Although many UAS paths appear complex in 3D, their periodic structure becomes clearer along individual dimensions. Using the magnitude spectrum 355 produced by the frequency transformation 350, the periodic prediction module 160, such as a TFT implementation, models repeating patterns on a per-axis basis while preserving the spatial relationships needed to reconstruct the full three-dimensional trajectory.

### Training, Reconstruction, and Output

The periodic prediction module 160 is trained on a diverse range of periodic motion data, from simple sinusoidal trajectories to more complex piecewise-periodic signals derived from real-world UAS behaviors such as corkscrew 230, figure eight 240, lawnmower 250, or spiral 260. During inference 520, each one-dimensional component 150 is predicted independently and then recombined into a unified three-dimensional forecast 540. A re-trending step 530 restores global motion characteristics, ensuring that the reconstructed trajectory 540 remains consistent with observed dynamics. The module outputs a single, high-confidence prediction 540 representing the most probable continuation of the periodic flight path, which is then supplied to downstream visualization and threat-assessment components within the overall FPP system.

### Non-Periodic Prediction Module

The non-periodic prediction module 170, illustrated in FIG. 7, is designed to forecast flight paths that exhibit irregular, evasive, or otherwise non-repetitive motion. In one embodiment, this module is implemented using a memory mechanism 630, which is well-suited for processing complex, non-linear trajectories. Unlike the periodic prediction module 160, such as a temporal fusion transformer, this module 170 addresses trajectories characterized by abrupt maneuvers, directional shifts, or context-driven behavior. The module 170 processes the UAS trajectory as a holistic spatiotemporal signal, incorporating both motion dynamics and environmental context when available.

FIG. 7 illustrates the outputs of this module. The input trajectory 710 serves as the observed path segment from which the system 100 initiates prediction. A set of N candidate trajectories 720 is generated to represent multiple plausible continuations of motion. These trajectories 720 form a probabilistic heatmap 730, which captures regions of higher and lower likelihood of the paths. From this probability distribution 730, the system identifies a most probable trajectory 740, representing the optimal predicted continuation of the UAS flight path.

### Memory-Enhanced Prediction Process

In certain embodiments, architecture employs a structured memory mechanism 630 that retains representative examples of diverse flight behaviors observed during training. When new flight data are received, the memory mechanism 630 performs a similarity-based retrieval to locate comparable patterns from memory. These retrieved “reference trajectories” serve as contextual anchors, allowing the model to refine its understanding of current motion and infer likely continuations based on analogous past behaviors.

### Probabilistic Forecast Generation

Rather than producing a single deterministic trajectory, the non-periodic prediction module 170 outputs a family of potential future paths 640 and 720 representing multiple plausible outcomes. These discrete trajectories 640 and 720 are aggregated into a continuous probabilistic heatmap 650 and 730, illustrated as a probability heatmap, that visualizes uncertainty over future motion. In the present embodiment, the relative likelihood of each region within this envelope is estimated using Kernel Density Estimation (KDE) or a comparable statistical smoothing technique. This process converts the discrete prediction set 640 and 720 into a continuous probability heatmap 650, allowing the system 100 to evaluate spatial likelihood gradients across the forecast region. The resulting density distribution conveys both confidence and variability in the prediction, enabling probabilistic reasoning in downstream decision and visualization modules.

### Optimization and Path Selection

Once the probabilistic prediction ensemble is generated, the system applies an optimization process to perform the optimal path selection 660, which extracts the most representative trajectory prediction 740 from the probability distribution 730. In one embodiment, this optimization operates directly over the probability heatmap, identifying a continuous path that maximizes traversal through high-likelihood regions. The candidate trajectory prediction 730 is evaluated using a scoring function that balances spatial continuity with the probability of occurrence, allowing the search to favor regions of higher predictive confidence rather than strictly minimizing geometric distance or time.

In the preferred embodiment, optimal path selection 660 operates directly over the probability heatmap, identifying a continuous path that maximizes traversal through high-likelihood regions. The heuristic adjusts dynamically according to the local probability density, ensuring that traversal through high-likelihood regions is prioritized. One representative formulation of this approach is expressed as:

$$score = 1 * {w}_{g} + {w}_{h} * - log ( \frac{1 - \vert {p}_{max} - {p}_{i} \vert}{{p}_{max}} ) \qquad Equation . 2$$

where g represents the accumulated path cost, pᵢ is the probability at node i, pₘₐₓ is the maximum probability in the search space, and w_{g} and wₕ are tunable weights that balance geometric efficiency against probabilistic optimality. The logarithmic transformation compresses extreme differences in probability and prevents instability in low-density regions, resulting in smoother, more realistic trajectory extraction.

The search concludes when it reaches a termination region corresponding to the intended or estimated endpoint of the UAS trajectory. The resulting path represents the system's best estimate of the UAS's future motion while maintaining continuity and adherence to high-likelihood regions within the cone.

In alternate embodiments, this optimization may also be performed using continuous trajectory fitting, dynamic programming, or variational techniques that similarly minimize a cost function composed of spatial smoothness and probability density terms. This flexibility allows the system to adapt the optimization strategy to different data resolutions and operational constraints.

What is claimed is:

1. A multi-model flight path prediction system for an unmanned aerial system, comprising:
a. a sensor fusion stage configured to produce positional track data;
b. a frequency analysis module configured to transform the positional track data into a frequency-domain representation and evaluate a resulting spectrum to determine whether an underlying motion pattern is periodic or non-periodic;
c. a control and routing mechanism configured to dynamically select a prediction pathway based on the determination of the motion pattern; and
d. a periodic prediction module optimized for recurrent flight behaviors, wherein the periodic prediction module generates a single trajectory forecast; and a non-periodic prediction module configured to model motion, wherein the non-periodic prediction module generates a set of candidate future paths.

2. The system of claim 1, wherein the frequency analysis module is configured to classify the motion pattern as periodic when energy within representative frequency ranges exceeds a threshold.

3. The system of claim 1, wherein the frequency analysis module utilizes a Discrete Fourier Transform (DFT) to transform the positional track data into the frequency-domain representation.

4. The system of claim 1, wherein the periodic prediction module is implemented using a transformer-based temporal model capable of learning periodic dependencies.

5. The system of claim 1, wherein the non-periodic prediction module is implemented using a memory-augmented network architecture.

6. The system of claim 1, wherein the control and routing mechanism is configured to dynamically change to an alternative prediction module if ongoing data indicates a transition in behavior.

7. The system of claim 1, wherein the system supports concurrent operation of the frequency analysis module and the prediction modules, and wherein the control and routing mechanism selects an appropriate prediction result for downstream use based on the frequency analysis output.

8. A method for predicting a flight path of an unmanned aerial system, the method comprising:
a. generating positional track data defining an input path for the UAS;
b. analyzing the positional track data in the frequency domain to characterize a motion pattern;
c. classifying the motion pattern as one of periodic or non-periodic based on the frequency domain analysis;
d. dynamically routing the positional track data to a corresponding prediction module using a control and routing mechanism; and
e. generating a trajectory forecast using the corresponding prediction module based on the classification.

9. The method of claim 8, wherein analyzing the positional track data includes:
a. decomposing the positional track data into one-dimensional signals along three spatial axes, and
b. applying a frequency-domain transform to each spatial component.

10. The method of claim 8, wherein classifying the motion pattern includes:
a. computing a ratio of spectral band power in a periodic frequency band to spectral band power in a non-periodic frequency band for each axis, and
b. evaluating the ratio against an empirical threshold.

11. The method of claim 8, further comprising preprocessing the positional track data by smoothing, normalizing, and detrending the data to isolate oscillatory components that contribute to periodic motion signatures.

12. The method of claim 8, wherein generating a trajectory forecast via the non-periodic prediction module includes producing multiple candidate trajectories representing plausible future outcomes.

13. The method of claim 12, further comprising transforming the discrete candidate paths into a continuous probability field using a statistical smoothing technique.

14. The method of claim 13, further comprising identifying a most probable trajectory forecast from the probabilistic heatmap via a path selection process.

15. The method of claim 14, wherein the path selection process is performed through a graph-based search that utilizes a scoring function balancing spatial continuity with a probability of occurrence.

16. A non-periodic flight path prediction system for an unmanned aerial system, comprising:
a. a non-periodic prediction module configured to capture non-repetitive dynamics and generate a set of candidate future paths; and
b. a processor configured to aggregate the candidate future paths into a probabilistic heatmap, wherein the probabilistic heatmap is a three-dimensional probabilistic forecast representation that visualizes uncertainty over future motion.

17. The system of claim 16, wherein the probabilistic heatmap highlights higher-probability regions of travel and is used for decision-making.

18. The system of claim 16, wherein the non-periodic prediction module employs a memory mechanism configured to retain representative examples of diverse flight behaviors observed during training.

19. The system of claim 18, wherein the memory mechanism is configured to perform a similarity-based retrieval to locate comparable reference trajectories when new flight data are received.

20. The system of claim 16, wherein aggregating the candidate future paths into a probabilistic heatmap utilizes a statistical smoothing technique.
